(19) United States
(12) Patent Application Publication
(10) Pub. No.: US 2009/0324804 A1
(43) Pub. Date: Dec. 31, 2009

(54) METHOD AND DEVICE FOR COATING SUBSTRATE SURFACES

(75) Inventors: Helmut Horsthemke, Solingen (DE); Franz-Josef Stark, Zulpich (DE)

Correspondence Address: SENNIGER POWERS LLP, 100 NORTH BROADWAY, 17TH FLOOR, ST LOUIS, MO, 63102, US

(73) Assignee: ENTHONE INC., West Haven, CT (US)

(21) Appl. No.: 12/278,256

(22) PCT Filed: Jan. 26, 2007
(86) PCT No.: PCT/EP07/00658

§ 371 Date: Dec. 15, 2008

(30) Foreign Application Priority Data
Feb. 2, 2006 (EP) 06002099.7

(51) Int. Cl. B05D 1/18; B05C 11/00

(52) U.S. Cl. 427/8; 118/665

(57) ABSTRACT

The invention relates to a method for coating substrate surfaces with a metal or oxide layer in a coating bath. Said bath has at least one component the concentration of which changes during the coating process and which therefore has to be replenished or removed in order to maintain the quality of the bath. The method according to the invention is characterized in that the component is replenished and/or removed depending on the strength of the composition of the bath.

The present invention relates to a process and apparatus for coating substrate surfaces with a metallic or oxidic layer in a coating bath.

In the field of surface technology different processes are known, with the aid of which the property of a substrate surface can be changed to suit a specific application. Such processes are for instance the deposition of metallic layers on substrate surfaces or the formation of oxide layers and preserving layers.

If a substrate layer has to be covered with a metallic coat, the substrate to be coated is contacted with a treatment solution which contains the metal to be deposited in the form of its cations. By a reduction, the dissolved cations can be deposited as a metallic layer on the substrate surface. Here, the reduction can be effected with the aid of a voltage applied between the substrate and a counter electrode or also by means of dissolved reducing agents. Hence, the coating techniques are concerned with galvanic (electrochemical) or autocatalytic (electroless) coating techniques.

By means of these two coating variants, a great number of metals or metal alloys can be deposited through correspondingly adapted techniques both on conducting and non-conducting substrate surfaces.

In addition to the metal cations and possibly reducing agents contained in the treatment solution, the treatment solutions, which are generally referred to as electrolytes, contain further additives which particularly influence the properties of the deposited layers such as the residual compressive stress or the hardness.

In addition to the processes for the deposition of metal layers on substrates, processes for the formation of oxide layers on the substrate surfaces are known. As an example, the anodic oxidation of aluminum materials may be mentioned which results in an improved corrosion protection.

The above-mentioned processes have in common that the electrolytes which are used change their composition in the course of the treatment process. In the process for the deposition of metallic layers on substrates the electrolyte is depleted of the ions of the metal to be deposited. For maintaining a metal ion concentration sufficient for the deposition of the metals, the electrolytes must be supplemented with components releasing corresponding metal ions. A measure of the efficiency of an electrolyte is the number of so-called metal turnovers (MTO). Here, the turnover of the original metal concentrations present in the electrolyte corresponds to one MTO.

However, by tracking the metal ion concentration in the electrolyte, not only metal ions are supplied to the electrolyte but also corresponding anions or complex reagents. Thereby the original composition will become extremely modified, which fact may lead to a negative influence on the coating result. In the course of the process management, a point will be reached at some time where a satisfying deposition result can no longer be achieved with a corresponding electrolyte. The service life of prior art electrolytes for the autocatalytic deposition of metals normally amounts to approximately 3 MTOs, provided that a constant quality of the coat must be reached.

The corresponding new preparation of an electrolyte and the disposal of the used-up electrolyte constitute decisive cost factors in the field of surface technology.

The present invention is therefore based on the object of providing a process and an apparatus with which the service life of an electrolyte can be significantly extended, whereby both an economically and ecologically improved applicability of the electrolytes is achieved.

Concerning the process, this object is solved by a process for coating substrate surfaces with a metallic or oxidic layer in a coating bath, wherein the bath includes at least one component, of which the concentration changes in the course of the coating process and which has to be supplemented or removed for maintaining the quality of the bath, characterized in that the supplementation and/or removal of the electrolyte component takes place in dependence of the density of the composition of the bath.

It has been found out that the density of the electrolyte composition constitutes a suitable measure of the state of an electrolyte over its lifetime.

Accordingly, it has been found out that for instance in the autocatalytic deposition of nickel, the best deposition results are achieved in a density range between 1.05 and 1.3 g/cm³. If the density exceeds a value of 1.3 g/cm³, satisfying deposition results are no longer achieved. In the course of the coating process and the tracking of the electrolyte components, the density is successively increased.

For this reason, the invention is based on the idea of maintaining the density of the electrolyte composition in the balanced state, i.e. in a state in which optimum coating results are obtained, by appropriate means, so that the density is not further increased in the course of the process.

According to the invention, this is obtained by the fact that the density of the electrolyte is determined, that the determined density value is compared with a stored reference density value for an optimum electrolyte composition, i.e. an electrolyte composition in the balanced state, and that in dependence of the deviation of the determined density value from the reference density value at least one component is either removed from and/or supplemented in the electrolyte.

In the practice, this can be effected by the electrolyte being continuously withdrawn a tunable amount of the electrolyte composition from the coating bath, whereby the electrolyte is artificially entrained.

By the tracking of electrolyte compositions in the balanced state, the lifetime of the electrolyte is no longer limited, which goes easy on resources. Moreover, by the process according to the invention, layers are deposited with the electrolyte remaining constant, which fact leads to constant coating results and to properties of the coats such as for instance an invariably high residual compressive stress over the entire period of use of the electrolyte.

The determination of the density of the electrolyte composition can be made continuously or discontinuously during the coating process. The determined density value of the coating bath is compared according to the invention with a reference density value, and the addition and/or removal takes place in dependence of the deviation of the determined density value from the reference density value. For this purpose, the reference density value can be stored in a data storage unit. The reference density value can then be compared with the determined density value of the coating bath, by means of a computer unit. The computer unit detects the deviation of the current density value of the coating bath from the reference density value and determines the amount of the electrolyte composition or at least the amount of a component thereof that is to be removed and/or added.

Advantageously, the computer unit controls an electronically controllable removing and/or adding device for removing or supplementing the electrolyte composition or at least a component of the electrolyte composition, providing that the density of the coating bath is matched with the stored reference density value.

Advantageously, the removed amount of electrolyte or electrolyte component can be collected and supplied to central recycling. Further advantageously, in the process according to the invention, electrolytes in a balanced state can be used in the first place and can be maintained in this balanced state by means of the process of the invention. Hence, an electrolyte is readily available to the user which produces constant coating results immediately, i.e. without a start-up period.

The process according to the invention can be applied to both the galvanic and autocatalytic deposition of metal layers and metal alloy layers on surfaces of a substrate. In addition to that, the process according to the invention can be employed also in treatment solutions for the formation of an oxide layer on the surface of a metallic substrate. These treatment solutions too can be optimized by controlling the density of the treatment solution. The anodization of aluminum surfaces are mentioned as an example.

Concerning the apparatus, the object of the invention is solved by an apparatus for the continuous removal and/or addition of at least one electrolyte component of an electrolyte for coating substrate surfaces with a metallic or oxidic layer, said apparatus for the removal and/or addition of at least one electrolyte component comprising a device for the determination of the density of the electrolyte and a computer unit, said device for the removal and/or addition of at least one electrolyte component being controlled by the computer unit which compares the density value determined by the device for the determination of the density of the electrolyte with a stored reference density value, providing that the density of the electrolyte is matched with the predetermined reference density value stored in the data storage device, by the addition and/or removal of at least one component of the electrolyte.

Advantageously, the device for the addition and/or removal can be a pump or a valve.

The device for the determination of the density can be a pycnometer, refractometer, densimeter, density balance, flexural resonator or any other device suitable for the determination of the density. Alternatively, the density can be determined indirectly through the refractive index of a refractometer.

Advantageously, the apparatus according to the invention can include additional devices for the determination of the properties of the bath such as temperature, conductivity, pH, specific extinction and absorption, cloudiness, wherein the values determined by these devices can be also sent to the computer unit and compared with reference values which are stored in the storage device, the computer unit being adapted for controlling additional devices like heating and cooling systems influencing the detected properties of the bath, providing that the properties of the bath are matched with the stored reference values.

Advantageously, the apparatus according to the invention can be incorporated in existing coating systems. The amounts of electrolyte or at least of a component of the electrolyte removed by means of the apparatus can be collected in suitable facilities and supplied to central recycling. Suitable facilities are for instance deposit containers, tank systems and the like.

With the process according to the invention and with the apparatus according to the invention it is possible not only to increase the lifetime of an electrolyte but also to double the operating time between the necessary passivating cycles of coating systems. With coating processes and apparatuses known from prior art, a passivation is required for instance every day to every second day for plastic containers and every week to every second week for stainless steel tanks. Due to the process according to the invention, this frequency is only every second day to every fourth day for plastic tanks and approximately every second week to every fourth week for stainless steel tanks. Thereby additional economical and environmental advantages can be obtained by reducing dead times and washing losses during cleaning of coating systems.

In a particularly advantageous manner the process according to the invention and the apparatus according to the invention can be combined with further processes and apparatuses, for improving the application time of the electrolyte compositions. Accordingly, the process of the invention can be combined for instance with a process for the electroless deposition of metals according to European patent application EP 1 413 646 A2, in which process metal base salts are used, of which the anions are volatile. The increase in density occurring in the course of the service life of an electrolyte is thereby reduced due to the escape of anions from the electrolyte composition, and this can even be optimized by a combination with the process according to the invention and with an apparatus according to the invention. Such an electrolyte for the electroless deposition of metal layers, preferably nickel, copper, silver or gold, contains a metal base salt, a reducing agent, a complex former, a catalyst and a stabilizing agent, wherein the electrolyte includes as a metal base salt a metal salt, of which the anions are volatile, preferably at a concentration of 0.01 to 0.3 mol/l. This metal salt, of which the anions are volatile, preferably is at least a salt from the group consisting of metal acetate, metal formate, metal nitrade, metal oxalate, metal propionate, metal citrate and metal ascorbinate, preferably metal acetate.

Especially by the use of metal salts, of which the anions are volatile, preferably metal acetates as electrolyte base salt, the lifetime of the electrolyte can be extended, while obtaining high depositing speeds and uniformly deposited layers at constant qualities of the layers. At the same time layers with residual compressive stress are deposited.

Basically, such an electrolyte is composed of one or more metal base salts, preferably metal acetate, and a reducing agent, preferably sodium hypophosphite. Further, to the electrolyte is added various additives like complex formers, catalysts and stabilizing agents which are preferably employed in acidic electrolytes for electroless deposition of nickel. Since the deposition speed is clearly higher in the acidic milieu, an acid is preferably added as a complex former to the electrolyte. The use of carboxylic acids and/or polycarboxylic acids turned out as particularly advantageous, since the same cause an advantageous solubility of the metal salts and the aimed control of the free metal ions on one side and on the other side predetermines or facilitates the adjustment of the pH required for the process, due to their acid strength. Advantageously, the pH of the electrolyte is within a range of 4.0 to 5.2. In addition to that, the dissolved metal is most advantageously complexly bound by the use of carboxylic acids and/or polycarboxylic acids, their salts and/or derivatives, preferably hydroxide, (poly)carboxylic acids, particularly preferred 2-hydroxy-propane acid and/or propane diacid. These compounds simultaneously serve as activators and as pH buffers and considerably contribute to the stability of the bath due to their advantageous properties.

Advantageously, a sulfur-containing heterocycle is added as a catalyst to the electrolyte. As a sulfur-containing heterocycle preferably saccharine, its salts and/or derivatives, most preferably sodium saccharine are used. In contrary to the S²⁻ based catalysts known from prior art and conventionally employed, the addition of saccharinate has no negative influence on the corrosion resistance of the deposited metal layers, not even at higher concentrations.

A further important pre-condition for a fast and high-quality deposition of metal layers is the use of suitable compounds for the stabilization of the electrolyte. For this purpose, a number of most different stabilizers are known in prior art. Considering, however, that the stability of the electrolyte according to the invention is decisively influenced by the use of metal salts, of which the anions are volatile, preferably acetates, formates, nitrates, oxalates, propionates, citrates and ascorbinates of the metals, most preferably metal acetate, only small amounts of stabilizers are preferably used. This is more economical on one hand and on the other hand avoids precipitations etc. which may occur due to the addition of additional substances and which may considerably shorten the lifetime of the electrolyte. Hence, advantageously only small amounts of a stabilizer are added to the electrolyte, in order to act contrary to a spontaneous decomposition of the metalizing bath. These can be for instance metals, halogen compounds and/or sulfur compounds like thioureas. Here, the use of metals as stabilizers turned out as particularly advantageous. In this case, the use of lead, bismuth, zinc and/or tin which are most preferably present in the form of a salt, of which the anions include at least one carbon atom, is preferred. The salts are preferably one or more salts from the group consisting of acetates, formates, nitrates, oxalates, propionates, citrates and ascorbinates and most preferably acetates.

Depending on whether the metal layers shall have additional properties, further components such as for instance additional metals, preferably cobalt, and/or finely dispersed particles are embedded in the layer in addition to phosphorus. Moreover, the electrolyte includes smaller amounts of additional components like for instance salts, preferably potassium iodide.

By the process herein described uniform metal layers at a turnover of at least 14 can be deposited, while the depositing speed is constantly high in a range of 7 to 12 μm/h at least.

Surprisingly, by applying the process according to the invention, the quality of the metalizing bath is improved and the lifetime considerably extended, even up to an unlimited lifetime of the metalizing bath. This fact results in the advantage that by the use of the process according to the invention not only high depositing speeds are obtained, but that the layers which have been deposited by the process are also uniform and high quality, exhibit a very good adhesive strength and are free of pores and cracks all over. Moreover, the metalizing of the surface of especially complex substrates is improved.

The process proposed with the invention is in a preferred embodiment characterized by the composition of the electrolyte in combination with the supplementation and/or removal of at least one bath component in dependence of the density. Advantageously, the process especially in this embodiment is economical compared to processes known from prior art and also environmentally friendlier.

An electrolyte of the type described above for the preferred implementation of the process according to the invention can substantially have the following composition for instance in the case of nickel plating:

| | |
|---|---|
| 4-6 g/l | nickel ions |
| 25-60 g/l | reducing agent |
| 25-70 g/l | complex former |
| 1-25 g/l | catalyst |
| 0.1-2 mg/l | stabilizer |
| 0-3 g/l | additional components |

The pH range of such a base electrolyte is between 4.0 and 5.0. As already described above, as metal recipient preferably metal salts are used, of which the anions are volatile. As metal salts, of which the anions are volatile, preferably one or more salts from the group consisting of metal acetates, metal formates, metal nitrates, metal oxalates, metal propionates, metal citrates and metal ascorbinates and most preferably exclusively metal acetate are used. Since during the reaction the pH decreases due to the continuous production of H*-ions and must be maintained in a complicated way in the target range by alkaline media such as hydroxide, carbonate or as normally preferred by ammonia, a particular advantage resides in the sole use of metal salts, of which the anions are volatile and which preferably come from the group of the acetates, formates, nitrates, oxalates, propionates, citrates and ascorbinates. The reason for this is that at the deposition of metal-phosphorus layers, anions of the acetates, formates, nitrates, oxalates, propionates, citrates and ascorbinates react with the sodium cations from the sodium hypophosphite to form alkaline sodium salts. Accordingly, during the entire deposition process the electrolyte works in a pH range of 4.0 to 5.2, preferably 4.3 to 4.8, without the necessity of adding higher amounts of alkaline media. Through this highly advantageous pH self-control, any continuous pH control as well as alkaline additives can be dispensed with during the process.

Relating to nickel, the concentration of the metal base salts amounts to 0.04 to 0.16 mol/l, preferably to 0.048 to 0.105 mol/l, the metal content lying between 0.068 and 0.102 mol/l and preferably at 0.085 mol/l.

As a reducing agent sodium hypophosphite at a concentration from 25 to 65 g/l is preferably used.

As already explained above, as complex formers carboxylic acids and/or polycarboxylic acids, their salts and/or derivatives, preferably hydroxy-(poly)carboxylic acids, still more preferably 2-hydroxy-propane acid and/or propane diacid are used. By using these compounds the dissolved nickel is complexly bound in a particularly advantageous way, so that at the continuous addition of such complex formers the deposition speed can be kept within a corresponding interval of 7 to 14 μm/h, preferably 9 to 12 μm/h. The concentration of the complex formers in the base electrolyte lies between 25 and 70 g/l, preferably 30 to 65 g/l.

The concentration of the catalyst, wherein preferably a sulfur-containing heterocycle, more preferably saccharine, its salts and/or derivatives, and even more preferably sodium saccharine is used, lies at 1 to 25 g/l, preferably 2.5 to 22 g/l. As stabilizers a halogen compound and/or sulfur compound, preferably thiourea, can be used. But particularly advantageous is the use of metals, preferably lead, bismuth, zinc and/or tin, preferably in the form of salts, of which the anions are volatile. These salts preferably come from the group consisting of acetates, formates, nitrates, oxalates, propionates, citrates and ascorbinates. Even more preferred are the nitrates of the metals used as stabilizers. The concentrations of the stabilizers advantageously lie at 0.2 to 2 mg/l, preferably at 0.3 to 1 mg/l.

Optionally, further components can be added to the base electrolyte, such as for instance potassium iodide at a concentration of 0 to 3 g/l.

Many different types of substrates are contacted with and galvanized in this base electrolyte. For supporting the lifetime and the stability of the electrolyte the same can be regenerated by means of electrodialysis and/or ion exchange resins during the deposition process. Also supplementing solutions (examples thereof are given below) can be added to the electrolyte during the deposition process. These supplementing solutions are specially composed for the regulation of the individual content of the base components and are added to the electrolyte in different amounts.

A first supplementing solution for instance has the following composition:

| | |
|---|---|
| 500-580 g/l | reducing agent |
| 5-15 g/l | complex former |
| 50-150 g/l | alkaline buffer |
| 11-20 g/l | catalyst |
| 0-3 g/l | additional component |

Advantageously, at the preparation and use of the supplementing solution the same substances as in the base electrolyte are employed. This results in a further very important advantage of the process according to the invention. Due to the fact that the same substances are continued to be used and that almost no pollution and precipitation occurs, even the compounds from the back-wash can be returned to the electrolyte. Thus the process according to the invention has a closed cycle of materials which makes the process more economical and environmentally friendlier. The complex former content and the content of alkaline buffer are selected such that the result is a total content of the complex formers in the electrolyte of 70 to 90 g/l.

At the same time, the content of the catalyst in the electrolyte is regulated such that for instance in the case of a nickel electrolyte and the use of sodium saccharinate as a catalyst an amount between 0.100 and 0.200 g, preferably 0.150 g, is supplemented for each gram of deposited nickel.

A second supplementing solution for instance can have the following composition:

| | | |
|---|---|---|
| 10-50 | g/l | complex former |
| 0.68-2.283 | mol/l | metal recipient |
| 1-25 | g/l | catalyst |
| 40-80 | mg/l | stabilizer |

Here, the complex former of the second supplementing solution can be the same as that of the first supplementing solution or can be different, if required. For instance, for a content of a hydrocarboxylic acid, e.g. 60 g/l of 2-hydroxy-propane acid, a hydrocarboxylic acid, e.g. propane diacid with a content of 0.5 g/l can be used as a second complex former in the base electrolyte. By means of dosing the supplementing solution the content of the propane diacid is then increased by 0.005 to 0.015 g for each gram of deposited nickel.

With such a stock and with the appropriate supplementing solution and if metal sulfate is used in addition to the previously described metal base salts a deposition of adherent metal layers with residual compressive stresses at a turnover of at least 14 MTO is guaranteed. Alone if base salts are used, of which the anions have at least one carbon atom and which preferably come from the group consisting of acetates, formates, oxalates, propionates, citrates and ascorbinates, the lifetime of the electrolyte continues to increase. Here, the above-mentioned residual compressive stress is a highly important and extremely desirable layer property. It positively influences the alternating bending stress and increases ductility. In the case of nickel for instance, metal layers having a ductility of >0.5% are deposited. In the same way, the remaining compressive stresses have a positive influence on the corrosion resistance of the metal-phosphorus layers.

Additionally, further components such as additional metals, preferably copper, and/or finely dispersed particles such as e.g. finely dispersed particles of fluorine-containing thermosetting plastic, can be added to the electrolyte and to the supplementing solutions, by which components additional hardness and dry lubrication effects and/or other properties are achieved in the deposited layers.

For the detailed illustration of the invention, a preferred embodiment of the electrolyte which can be preferably used in the process of the invention is described in the following.

### EXAMPLE 1

| | | Supple- | Supple- |
|---|---|---|---|
| | | menting | menting |
| Composition | Electrolyte | solution RA | solution SA |
| nickel acetate-4-hydrate (g/l) | 12.5-25.5 | / | 200-212 |
| sodium hypophosphite (g/l) | 30-50 | 515-565 | / |
| hydroxycarboxylic acid (g/l) | 32-55 | / | 25-35 |
| hydroxypolycarboxylic acid (g/l) | 0.5-5 | / | / |
| sodium saccharine (g/l) | 2.5-22 | 12.5-15 | / |
| potassium iodide (gl) | 0.1-2 | 1-2 | / |
| lead acetate (mg/l) | 0.3-1 | / | 60-65 |
| ammonium 25% by weight (m/l) | 100-150 | | |

Such an electrolyte has a self-regulating pH range of 4.3 to 4.8 and allows depositing speeds of 8 to 12 μm/h. The internal stress of layers deposited therefrom amounts to −10 to −40 N/mm². When using the above-described electrolyte composition metal-phosphorus layers having invariably good properties are produced.

By increasing the pH range to 4.6-5.2, layers having a residual compressive stress of 0 to −15 N/mm² are deposited. The establishment of this second pH interval leads to a significant increase in the deposition speed to 12-20 μm/h. The phosphorus content of these layers amounts to 8-10% P. By further increasing the pH range to 5.5-6.2 layers having residual compressive stresses of −5 to −30 N/mm² are deposited. The phosphorus content of these layers amounts to 2-7% P.

Moreover, the process according to the invention and the apparatus according to the invention can be advantageously combined also with electrodialysis processes and apparatuses and other means for the regeneration of coating compositions. For instance, the electrolyte according to the invention can be regenerated by means of electrodialytical processes. When using metal salts, of which the anions are volatile, the separating effect of the electrodialysis system is significantly increased. At an equal salt charge of electrolytes containing orthophosphate ions but no sulfate ions the number of electrolysis cells for the separation of orthophosphite ions can be reduced, while the separation efficiency remains the same.

In a further embodiment of the process according to the invention, in the case of an electrolyte containing hypophosphite as a reducing agent, the removed and collected amounts of electrolyte are supplied to the phosphate recovery in a central recycling. Here, the orthophosphate which has been produced by the autocatalytic separation reaction according to the general formula

MSO₄+6NaH₂PO₂→M+2H₂+2P+4NaH₂PO₃+Na₂SO₄

can be recovered as phosphate and used again in a cycle of materials for the production of new electrolyte compositions.

In a particularly preferred embodiment of the process according to the invention a substrate to be coated is coated in a process for coating substrate surfaces with a metal layer in a coating bath, wherein the coating bath at least comprises one component, of which the concentration changes in the course of the coating process and which consequently must be supplemented or removed for maintaining the quality of the bath, wherein the supplementation and/or removal of the component takes place in dependence of the density of the composition of the bath, and the composition of the bath contains a metal base salt, a reducing agent, a complex former, a catalyst and a stabilizer, wherein the composition of the bath contains metal base salt as metal salt, of which the anions are volatile, and which is present at an initial concentration of 0.01 to 0.30 mol/l.

By the combination of an artificial entrainment and a tracking of the used-up bath components in dependence of the density, the use of electrolytes containing volatile anions and the use of electrolytes being in a balanced state in the first place, there is provided with the process according to the invention for the first time a coating process for the electroless coating of substrate surfaces, which coating process theoretically has an unlimited useful life. Accordingly, the new preparation of metalizing baths is avoided, whereby resources are spared, so that ecological and economical advantages are achieved which have never been achieved before.

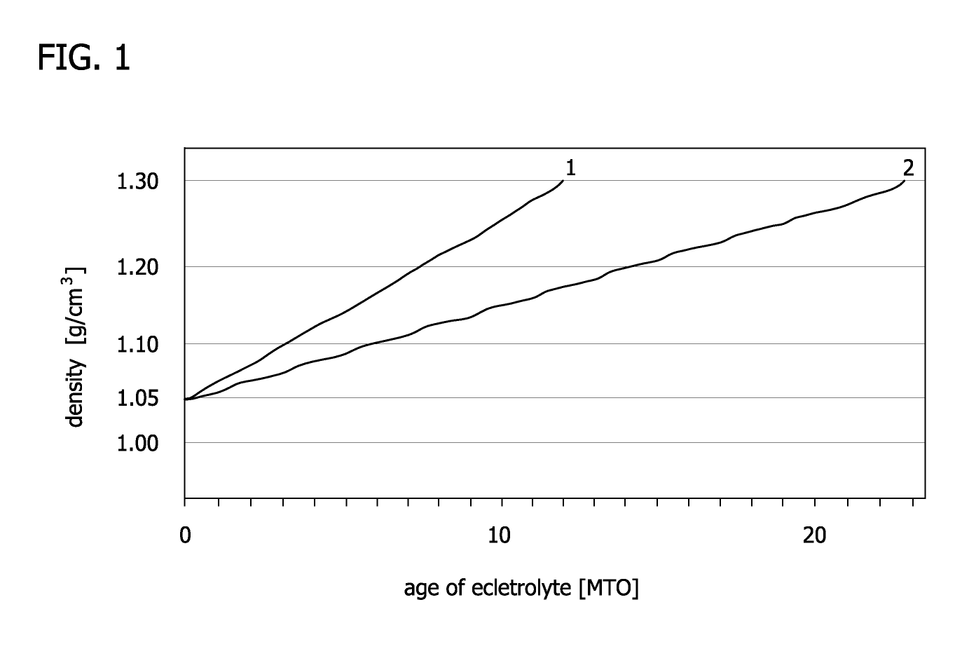

FIG. 1 shows the density characteristics of an electrolyte in dependence of the operation time.

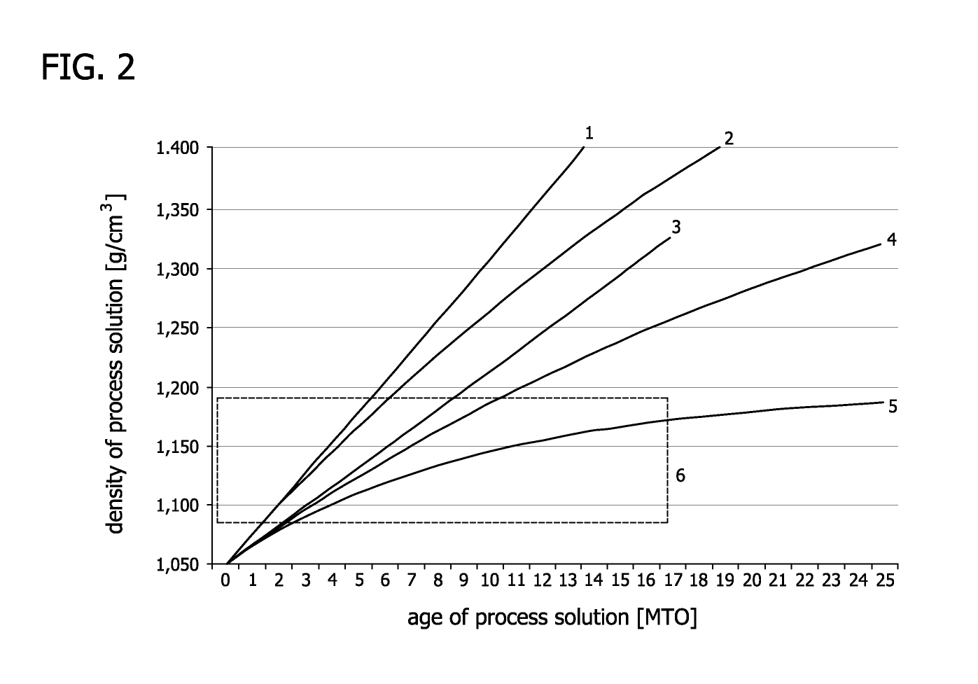

FIG. 2 shows the increase in density for different amounts of removal for conventional electrolytes and those according to the European patent application EP 1 413 646 A2.

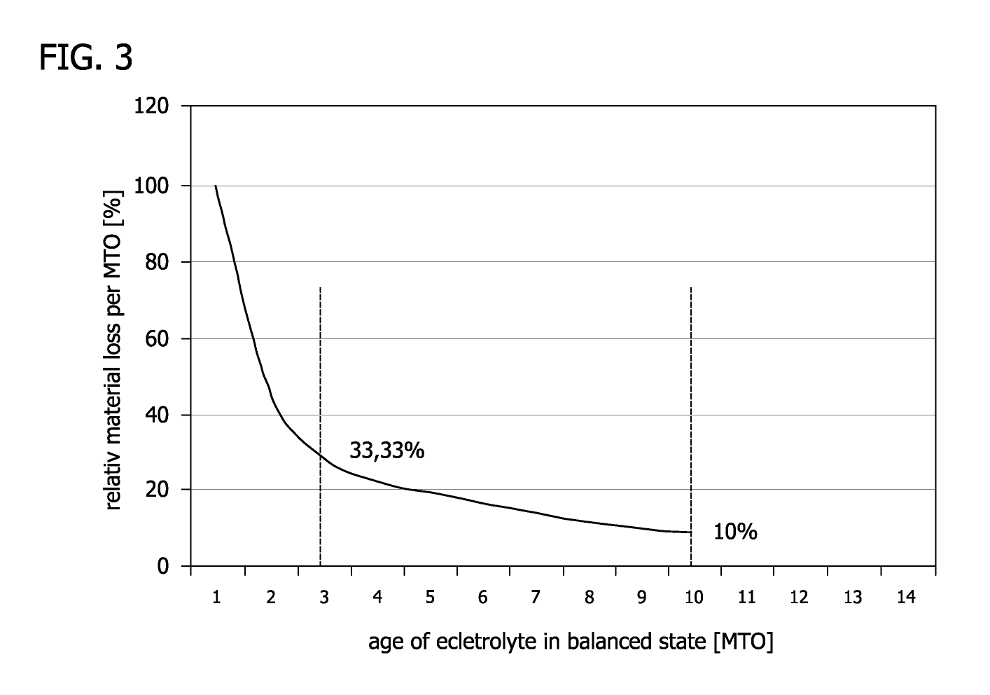

FIG. 3 shows the material loss in electrolytes at constant operation.

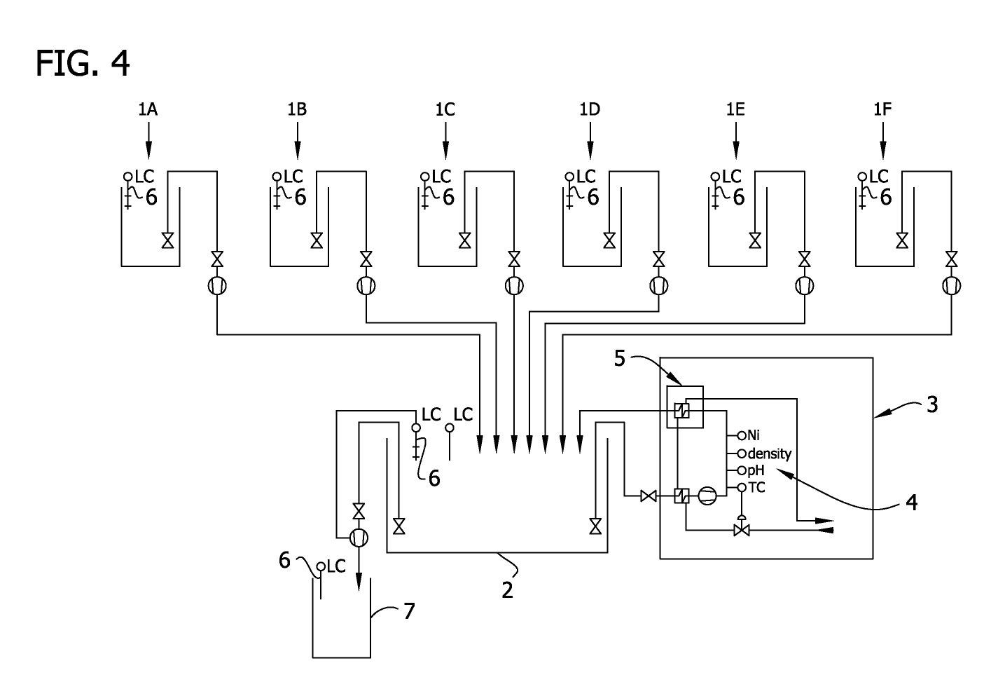

FIG. 4 shows a process diagram of the apparatus according to the invention.

In FIG. 2 the density characteristics of different electrolyte compositions in dependence of the operation time of the electrolyte and the removed amount of electrolyte is shown. Graph no. 1 shows the density characteristics of an electrolyte for the deposition of nickel layers known from prior art. Graph no. 2 shows the density characteristics of a prior art electrolyte for the deposition of a nickel layer at a set amount of electrolyte removal of 3.3%. Graph no. 3 shows the density characteristics of an electrolyte of the type known from the European patent application EP 1 413 646 and in which metal salts, of which the anions are volatile, are used as metal base salt of the electrolyte composition. Graph no. 4 shows the electrolyte described in connection with graph no. 3 at a set amount of electrolyte removal of 3.3%. Graph no. 5 shows the electrolyte described in connection with graph no. 3 at a set amount of electrolyte removal of 10%.

The part in FIG. 2 which is identified by reference number 6 represents the optimum operating range for electrolytes. It can be seen here, that with a set continuous removal of 3.3% for an electrolyte composition known from EP 1 413 646 A2 10 MTOs are already achieved, without leaving the optimum operation range. With a set continuous removal of 10% the density upper limit of the optimum working range for an electrolyte known from EP 1 413 646 A2 is no longer reached, and theoretically the electrolyte composition has an unlimited service life.

FIG. 3 shows the relative material loss in the electrolyte for each MTO compared to the age of the electrolyte in the balanced state. The left border line represents a conventional electrolyte system. The right border corresponds to an electrolyte system according to EP 1 413 646 A2.

FIG. 4 shows a process diagram of an apparatus according to the invention. From the component containers 1A to 1F individual components required for the preparation of the electrolyte are supplied to the electrolyte bath 2 by suitable transportation means, for instance by pumps. The electrolyte composition which is present in the electrolyte bath 2 is analyzed for its chemophysical properties like density, pH, temperature, conductivity or metal content either directly in the electrolyte bath or in an external control module 3 supplied with a partial flow from the electrolyte bath. If a partial flow of the electrolyte is taken out from the electrolyte bath 2, the same can be optimally supplied to a heat recovery 5. Now, removal amounts fixed in dependence of the determined values can be removed from the electrolyte by means of suitable pumps and supplied to a reception container 7. Both the component containers 1A to 1F and the electrolyte bath as well as the reception container for the removed electrolyte advantageously include filling level sensors which register the level falling below or exceeding filling limits and output corresponding signals and/or initiate corresponding process management steps for maintaining the non-disturbed coating operation.

### LIST OF REFERENCE NUMBERS

1A-F component container
2 electrolyte bath
3 control module
4 sensor
5 optional heat recovery
6 filling level sensors
7 reception container for removed electrolyte

1-12. (canceled)

13. A process for coating substrate surfaces with a metallic or oxidic layer in a coating bath, wherein the bath includes at least one component, of which the concentration changes in the course of the coating process and which consequently must be supplemented or removed for maintaining the quality of the bath, wherein from the start of the process, the composition of the bath used has a density which correlates to a reference density value, and wherein during use the density of the bath is compared to the reference density value and supplementation and/or removal of at least one component is made in dependence of the density of the composition of the bath, and wherein uniform metal layers are deposited on substrate surfaces at a metal turnover of at least 14.

14. The process as set forth in claim 13, wherein supplementation of at least one component is made in dependence of the density of the composition of the bath.

15. The process as set forth in claim 14, wherein the bath comprises a metal base salt of which the anions are volatile.

16. The process as set forth in claim 15, wherein the metal base salt comprises an anion selected from the group consisting of acetate, formate, nitrate, oxalate, propionate, citrate, ascorbinate, and combinations thereof.

17. The process as set forth in claim 16, wherein the anion of the metal base salt is acetate.

18. The process as set forth in claim 17, wherein the metal base salt comprises nickel ions.

19. The process as set forth in claim 18, wherein the concentration of nickel ions is from 0.04 to 0.16 mol/l.

20. The process as set forth in claim 15, wherein the process further comprises regenerating the bath by electrodialysis and/or ion exchange during the coating process.

21. The process as set forth in claim 14, wherein the bath comprises:
(a) a metal base salt of which the anions are volatile, wherein the initial concentration of the metal ions is from 0.01 to 0.3 mol/l;
(b) a reducing agent;
(c) a complex former;
(d) a catalyst; and
(e) a stabilizing agent.

22. The process as set forth in claim 21, wherein the metal base salt comprises an anion selected from the group consisting of acetate, formate, nitrate, oxalate, propionate, citrate, ascorbinate, and combinations thereof.

23. The process as set forth in claim 13, wherein the determined density value of the bath is compared with the reference density value, and the supplementation and/or removal of at least one component is made in dependence of the deviation of the determined density value from the reference density value.

24. The process as set forth in claim 14 wherein the process is a process for forming an oxide layer on the surface of an aluminum substrate.

25. The process as set forth in claim 14, wherein the bath comprises:
(a) nickel ions at a concentration from 4 to 6 g/l;
(b) a reducing agent at a concentration from 25 to 60 g/l;
(c) a complex former at a concentration from 25 to 70 g/l;
(d) a catalyst at a concentration from 1 to 25 g/l; and
(e) a stabilizer at a concentration from 0.1 to 2 mg/l.

26. The process as set forth in claim 25, wherein the bath is supplemented with a first supplementing solution comprising:
(a) a reducing agent at a concentration from 500 to 580 g/l;
(b) a complex former at a concentration from 5 to 15 g/l;
(c) an alkaline buffer at a concentration from 50 to 150 g/l; and
(d) a catalyst at a concentration from 11 to 20 g/l.

27. The process as set forth in claim 26, wherein the bath is further supplemented with a second supplementing solution comprising:
(a) a complex former at a concentration from 10 to 50 g/l;
(b) a metal recipient at a concentration from 0.68 to 2.283 mol/l;
(c) a catalyst at a concentration from 1 to 25 g/l; and
(d) a stabilizer at a concentration from 40 to 80 mg/l.

28. The process as set forth in claim 14, wherein the bath comprises:
(a) nickel acetate-4-hydrate at a concentration from 12.5 to 25.5 g/l;
(b) sodium hypophosphite at a concentration from 30 to 50 g/l;
(c) hydrocarboxylic acid at a concentration from 32 to 55 g/l;
(d) hydroxypolycarboxylic acid at a concentration from 0.5 to 5 g/l;
(e) sodium saccharine at a concentration from 2.5 to 22 g/l;
(f) potassium iodide at a concentration from 0.1 to 2 g/l;
(g) lead acetate at a concentration from 0.3 to 1 mg/l; and
(h) 25 wt. % ammonium at a concentration from 100 to 150 ml/l.

29. The process as set forth in claim 28, wherein the bath is supplemented with a first supplementing solution comprising:
(a) sodium hypophosphite at a concentration from 515 to 565 g/l;
(b) sodium saccharine at a concentration from 12.5 to 15 g/l; and
(c) potassium iodide at a concentration from 1 to 2 g/l.

30. The process as set forth in claim 29, wherein the bath is further supplemented with a second supplementing solution comprising:
(a) nickel acetate-4-hydrate at a concentration from 200 to 212 g/l;
(b) hydrocarboxylic acid at a concentration from 25 to 35 g/l; and
(c) lead acetate at a concentration from 60 to 65 mg/l.

31. An apparatus for the continuous supplementation and/or removal of at least one component of a bath for coating substrate surfaces with a metallic or oxidic layer, said apparatus comprising a device for the supplementation and/or removal of at least one component, a device for determining the density of the bath, and a computer unit, wherein the device for the supplementation and/or removal of at least one component is controlled by the computer unit in dependence of the density value determined by the device for determining the density, wherein the computer unit compares the density value determined by the device for determining the density of the bath with a stored reference density value, providing that the density of the bath is correlated to the stored reference density value by the supplementation and/or removal of at least one component.

32. The apparatus as set forth in claim 31, wherein the device for determining the density is a pycnometer, refractometer, densimeter, density balance or a flexural resonator.
